(19) United States
(12) Patent Application Publication
(10) Pub. No.: US 2016/0125133 A1
(43) Pub. Date: May 5, 2016

(54) METHOD FOR POSITIVE FREQUENCY DATA ACCUMULATION AND APPARATUS FOR FILTERING GENETIC VARIANTS USING THE SAME

(71) Applicants: SAMSUNG SDS CO., LTD., Seoul (KR); SAMSUNG LIFE PUBLIC WELFARE FOUNDATION, Seoul (KR)

(72) Inventors: Chang Seok KI, Seoul (KR); Yoo Jin HONG, Seoul (KR); Woo Yeon KIM, Seoul (KR); Yong Seok LEE, Seoul (KR); Seong Hyeuk NAM, Seoul (KR)

(73) Assignees: SAMSUNG SDS CO., LTD., Seoul (KR); SAMSUNG LIFE PUBLIC WELFARE FOUNDATION, Seoul (KR)

(21) Appl. No.: 14/928,089

(22) Filed: Oct. 30, 2015

(30) Foreign Application Priority Data
Oct. 31, 2014 (KR) 10-2014-0150324

(51) Int. Cl. G06F 19/24

(52) U.S. Cl. CPC G06F 19/24

(57) ABSTRACT

Provided are a method and apparatus for accumulating positive frequency data. The method includes receiving result data of pooling tests performed on a plurality of pools on a two dimensional (2D) matrix, the pooling test result data including allele frequencies of positive pools for a standard variant, predicting the number of positive samples for the standard variant from the allele frequencies of the positive pools, calculating a positive frequency for the standard variant from the number of positive samples, and updating the positive frequency for the standard variant to positive frequency database.

### CROSS-REFERENCE TO RELATED APPLICATION

This application claims priority from Korean Patent Application No. 10-2014-0150324 filed on Oct. 31, 2014 in the Korean Intellectual Property Office, and all the benefits accruing therefrom under 35 U.S.C. 119, the contents of which in its entirety are herein incorporated by reference.

### BACKGROUND

1. Field of the Invention

The present invention relates to an apparatus and method for filtering genetic variants to prevent errors from being contained in genetic variants resulting from pooling tests of a plurality of biological samples. More particularly, the present invention relates to an apparatus and method for accumulating frequency data of occurrences of genetic variants and filtering potential false positive samples from the genetic variants of pooling test results.

2. Description of the Related Art

Technology for preventing specific viruses or diseases from being caused by examining genes causing the particular viruses or diseases is making progress. However, individually testing numerous kinds of biological samples may incur a tremendous time and considerable costs. Therefore, in order to reduce the incurred time and costs, various methods for pooling multiple biological samples and examining the pooled samples at the same time are being proposed.

Pooling tests for pooling and testing multiple biological samples are suitably used in a case where frequencies of occurrences of positive reactions to particular traits included in the biological samples are low. In the pooling tests, the respective samples are arranged on a two dimensional (2D) (n*m) matrix and the samples of the same row and the same column are pooled to be subjected to tests. Here, if there are many pools demonstrating positive reactions, it is difficult to determine which ones are positive samples. If multiple samples are determined to be positive samples and the positive samples are possibly determined as false positives, actual positive samples can be discriminated by performing individual tests on the corresponding samples. In this connection, advantageous merits of the pooling test, that is, cost and time saving effects, cannot be attained.

In a case of employing the pooling tests in testing samples with low positive frequencies, individual tests may be performed a reduced number of times and the cost and time saving effects can be advantageously exerted. Accordingly, it is necessary to develop a method for accumulating positive frequency data and a filtering apparatus using the same.

### SUMMARY

The present invention provides a method and apparatus for accumulating positive frequency data and filtering positive frequencies when the number of pooling test results is larger than the number of positive frequencies.

The present invention also provides a method and apparatus for calculating the number of positive samples by roughly predicting positive samples among all of pooled samples to rapidly accumulate positive frequency data resulting from pooling tests without discriminating actual positive samples.

The present invention also provides a method for supporting a variety of operators employed to attribute values of pre-accumulated items in recommending accumulation regions for items stored in a warehouse by employing a minimum number calculating method and a best guess calculating method, and an apparatus for performing the supporting method.

The present invention also provides a method for recommending storage partitions, for partitioning a storage region in a warehouse into a plurality of storage partitions and supporting flexible designation of requirements of items stored in the respective storage partitions, and an apparatus for performing the recommending method.

These and other objects of the present invention will be described in or be apparent from the following description of the preferred embodiments.

According to an aspect of the present invention, there is provided a method for accumulating positive frequency data for determining false positives, the method including the steps of receiving result data of pooling tests performed on a plurality of pools on a two dimensional (2D) matrix, the pooling test result data including allele frequencies of positive pools for a standard variant, predicting the number of positive samples for the standard variant from the allele frequencies of the positive pools, calculating a positive frequency for the standard variant from the number of positive samples, and updating the positive frequency for the standard variant to positive frequency database.

According to another aspect of the present invention, there is provided a method for filtering false positive samples from pooling test results, the method including the steps of detecting a standard variant of each pool, predicting the number of positive samples based on positive pool data for the standard variant, measuring positive frequencies using the number of positive samples, and comparing the measured positive frequencies with pre-accumulated positive frequency values and filtering the measured positive frequencies when the number of measured positive frequencies is beyond a predefined number of errors.

According to still another aspect of the present invention, there is provided a computer program recorded in a recording medium in association with a computing device, the computer program executing a method for filtering pooling test results using positive frequency data, the method including the steps of receiving result data of pooling tests performed on a plurality of pools on a two dimensional (2D) matrix, the pooling test result data including data concerning positive pools for a standard variant, measuring allele frequencies of the positive pools to predict the number of positive samples for a standard variant from the positive pool data, predicting the number of DNA strands having alleles of the respective positive pools from data concerning the allele frequencies of the positive pools, predicting the number of DNA strands having alleles of the respective samples contained in the positive pools from the number of predicted DNA strands having alleles of the respective positive pools, predicting positive samples from the number of predicted DNA strands having alleles of the respective samples, and predicting positive frequencies from the predicted positive samples.

According to a further aspect of the present invention, there is provided a pooling test apparatus for filtering false positive samples, the pooling test apparatus including one or more processors, a network interface, a memory, and a storage device loaded on the memory and having a computer program recorded therein, the computer program executed by the one or more processors, wherein the computer program includes a series of data receiving instructions of receiving data concerning positive pools as the result of pooling tests performed on a standard variant on a two dimensional matrix, a series of predicting instructions of measuring allele frequencies of the positive pools to predict the number of positive samples for the standard variant using the positive pool data, predicting the number of DNA strands having alleles based on the measured values of the allele frequencies, and predicting the number of positive samples based on the number of predicted DNA strands, and a series of calculating instructions of calculating positive frequencies based on the number of positive samples.

As described above, according to the present invention, since filtering is performed on pre-accumulated positive frequency values for a standard variant to be tested with respect to pooling test results, errors of the pooling test results can be prevented.

In addition, according to the present invention, when a positive frequency of the pool is excessively high, it is possible to provide a criterion for determining whether the positive frequency is actually high or whether there is a pooling error.

Further, according to the present invention, in a case where the standard variant has an excessively high positive frequency, which means that a pooling test is not appropriate, it is possible to determine whether the pooling test is suitable for detecting positive samples for the standard variant.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram illustrating a sample pooling process for generating data to be analyzed in a method for pooling error detection in consideration of the number of DNA strands according to an embodiment of the present invention;

FIG. 2 is a schematic diagram of a sample analysis system according to an embodiment of the present invention;

FIG. 3 is a schematic diagram of a sample analysis system according to another embodiment of the present invention;

FIG. 4 is a diagram illustrating an exemplary operation of discriminating positive samples using pooling test results;

FIG. 5 is a diagram illustrating an exemplary case where false positive samples are included in pooling test results;

FIG. 6 is a diagram illustrating a method for measuring allele frequency for a standard variant according to an embodiment of the present invention;

FIG. 7 is a diagram illustrating standard variant patterns;

FIG. 8 is a diagram illustrating allele frequencies in a case where the standard variant is B in two pools determined as positive pools;

FIG. 9 is a diagram illustrating a method for predicting the number of positive samples according to an embodiment of the present invention using a minimum number calculating method;

FIGS. 10A to 10C are diagrams illustrating a method for predicting the number of positive samples according to an embodiment of the present invention using a best guess calculating method;

FIG. 11 is a flowchart of a method for accumulating positive frequencies for determining false positives according to an embodiment of the present invention;

FIG. 12 is a block diagram of a pooling test apparatus for filtering false positives according to an embodiment of the present invention;

FIG. 13 is a diagram illustrating an algorithm of a best guess calculating method according to an embodiment of the present invention;

FIG. 14 is a graph illustrating comparison of the numbers of predicted positive samples with the number of actual positive samples; and

FIG. 15 is a hardware diagram of a pooling test apparatus according to an embodiment of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In the drawings, the size and relative sizes of layers and regions may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terminology used herein is for the purpose of describing particular embodiments only and is not intended to be limiting of the invention. As used herein, the singular forms are intended to include the plural forms as well, unless the context clearly indicates otherwise.

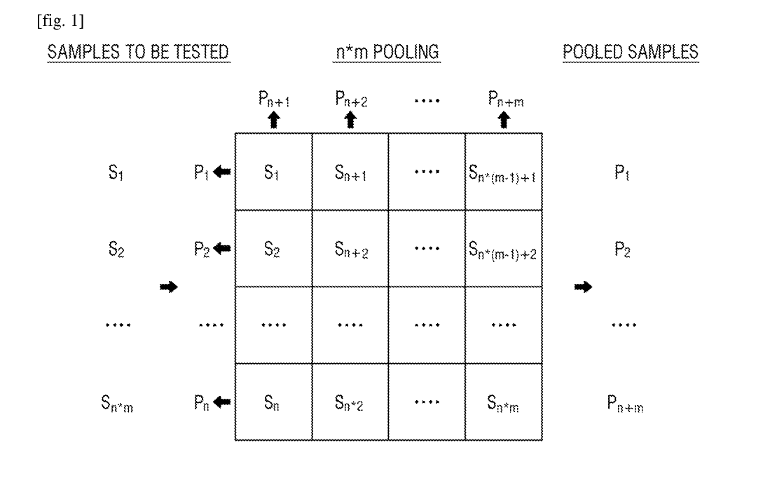

Hereinafter, a process of constructing pools from samples to be tested will be described with reference to FIG. 1.

First, X (X=n*m) samples to be tested (S₁, S₂, S₃, . . . , S_{n*m}) are arranged in a n*m matrix. Here, n and m may be equal to or different from each other. However, n*m should be equal to X, which is larger than or equal to 2. The samples to be tested are samples to be examined whether they have particular biological traits and may include tissues or body fluids of all kinds of organisms, including humans.

After the matrix is constructed, the X samples arranged in the matrix are pooled by dividing the X samples in k (=n+m) pools. Here, the samples having the same row or the same column in the matrix are pooled in the same pool. For example, in the illustrated embodiment, samples of the first row of the matrix are pooled in a pool P 1, and samples of the first column of the matrix are pooled in a pool Pₙ₊₁. Through this procedure, k pools of samples (P₁, P₂, P₃, . . . , P_{n*m}, each of which is to be briefly denoted by “pool”) are generated.

The samples pooled as illustrated in FIG. 1 may be tested whether they have particular traits, that is, they are samples having a standard variant. When samples having a standard variant are discriminated through pooling tests, the standard variant preferably has a low positive frequency. The term “positive frequency” used herein is a statistical concept representing occurrences of the samples having a standard variant.

In order to detect which one of the pooled samples has a standard variant in a pooling test for simultaneously testing multiple samples, a sample having a highly accurate standard variant can be detected when the sample is singly discriminated from an intersection of row and column on the two dimensional (2D) matrix.

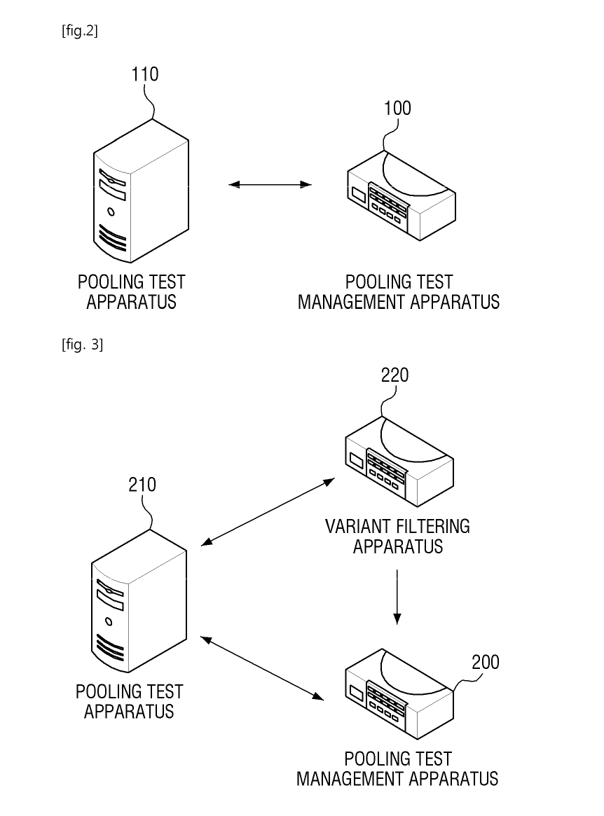

Hereinafter, the configuration and operation of a sample analysis system according to an embodiment of the present invention will be described with reference to FIG. 2. The sample analysis system according to an embodiment of the present invention includes a pooling test management apparatus 110 and a pooling test apparatus 100.

The pooling test management apparatus 110 is an apparatus for pooling a plurality of biological samples to construct pools of a 2D (n*m) matrix and testing whether the pools have particular biological traits. The pooling test management apparatus 110 may record data concerning each of the biological samples, e.g., data of blood collected from a human. The pooling test management apparatus 110 is configured to determine positive samples using the pools crossing each other in the matrix when each of the pools demonstrates a positive reaction satisfying a particular biological trait.

The pooling test apparatus 100 detects a standard variant from the constructed pools. If any one of the pools demonstrates a positive reaction to the standard variant, the number of positive samples contained in the positive pool can be predicted using allele frequency data of the positive pool. In addition, the genotype of the standard variant can be predicted by measuring the allele frequency of the positive pool.

In order to measure standard variant genotype signals, the pooling test apparatus 100 may employ next generation sequencing (NGS). The NGS allows reads corresponding to sequence fragments having constant lengths with respect to a targeted chromosome (DNA) region to be produced in large quantities. The thus produced reads are mapped to a reference sequence, and sequences of the corresponding region are reconstructed based on the sequence data of the reads mapped in a particular region.

In the aforementioned example, a genotype at a particular position for a sample to be tested can be predicted from the allele frequencies at corresponding positions of the reads mapped in the region including the corresponding positions. For example, in a case of a heterozygous genotype AB, the allele frequencies of A and B will be observed to be approximately ½ and ½, respectively. In addition, in a case where samples having genotypes AB and BB are pooled, the allele frequencies of A and B will be observed to be approximately ¼ and ¾, respectively. Therefore, in order to test whether a sample has a particular single base variant using the NGS, the allele frequency of the allele B present in the variant genotypes AB and BB is measured based on the mapped reads.

Meanwhile, when a diploid sample has a genotype AB in obtaining the allele frequencies based on the mapped reads using NGS, the allele frequency for the alternative allele B may not be always observed to be ½ or 1 in some cases. This may be caused due to several errors, such as a sequencing error or a mapping error. Therefore, when the allele frequency is observed to be in the range of between 0.4 and 0.6 with such errors taken into consideration, the sample is determined to have the genotype AB, and when the allele frequency is observed to be 0.8 or greater, the sample is determined to have the genotype BB. Accordingly, the rule may be applied to the samples such that the samples are assigned with the respective genotypes based on the determination results. Another approach for determining genotypes of samples based on the mapped reads may include statistical algorithm for computing a likelihood or a probability for a certain genotype, such as an SNVer algorithm (Wei et al., SNVer: a statistical tool for variant calling in analysis of pooled or individual next-generation sequencing data, Nucleic Acids Res. 39(19), 2011). The test result values may also be determined using the rule or algorithm in consideration of the number of pooled samples. However, the rule or algorithm may be provide only for illustrating an exemplary embodiment for implementing the present invention, but aspects of the present invention are not limited thereto.

In order to facilitate application of the NGS to the present invention, the sequencing results of the respective pools should satisfy the condition that sequenced reads of the samples pooled in the respective pools are distributed in an equilibrated manner. For example, assuming that four of pooled samples have genotypes AA, AB, AB and AA, respectively, the allele frequency for the replaced allele B should be observed to be approximately 2/8 in the corresponding pool.

The pooling test apparatus 100 according to an embodiment of the present invention may determine whether false positive samples are contained in the pooling test results using the pre-accumulated positive frequency data.

In pooling a plurality of biological samples, pooling of the respective samples should be equilibrated to prevent errors from being generated in pooling test results. For example, when positive samples are pooled in a larger quantity than a quantification limit, compared to other samples, the pools may have higher allele frequency values than equilibrated pools. In such a case, false positives may be determined and error may be contained in the pooling test results. In order to prevent the false positives from being contained in the pooling test results, the pooling test apparatus 100 according to the present invention may include database of positive frequencies.

The pooling test apparatus 100 may accumulate positive frequency data, which is a probability of occurrence of a particular standard variant in the positive frequency database, and may filter the positive frequency data having relatively high reliability, thereby preventing the pooling test results from being transferred to the pooling test management apparatus 110.

The pooling test apparatus 100 according to an embodiment of the present invention may employ a method for predicting only the number of positive samples to accumulate the positive frequency data without discriminating positive samples. In order to rapidly and simply predict the number of positive samples, a minimum number calculating method may be used. In addition, it is also possible to use a best guess calculating method, which is rather complex compared to the minimum number calculating method but is capable of obtaining the number of positive samples approximate to the number of actual positive samples.

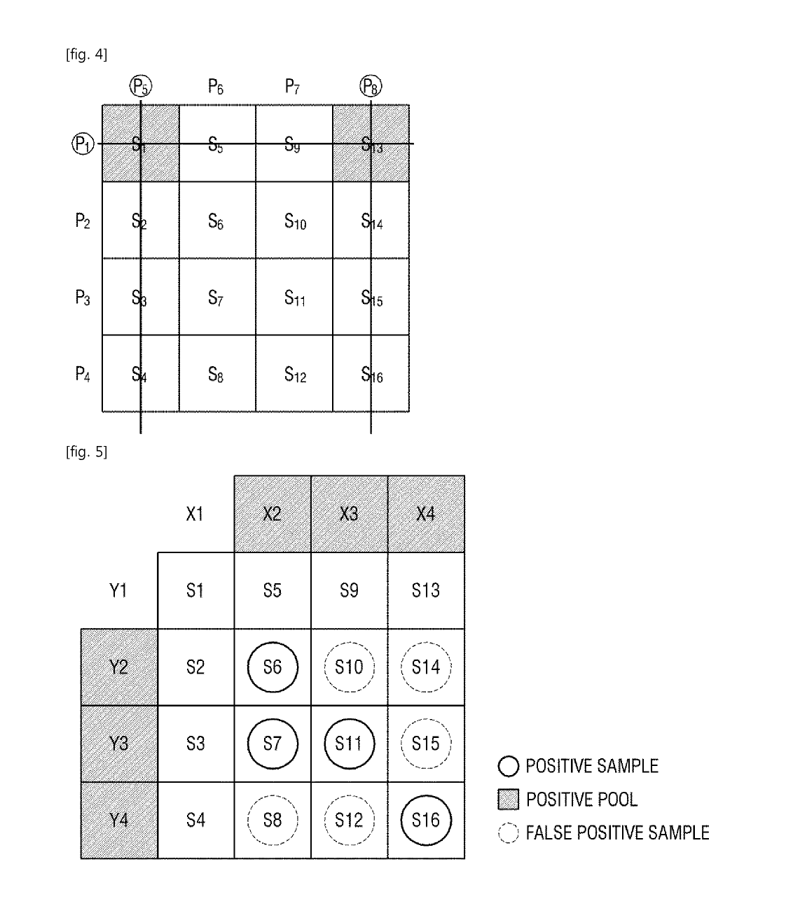

Hereinafter, the configuration and operation of a sample analysis system according to an embodiment of the present invention will be described with reference to FIG. 3. The sample analysis system according to another embodiment of the present invention includes a pooling test apparatus 200, a pooling test management apparatus 210 and a variant filtering apparatus 220.

The pooling test management apparatus 210 manages discrimination data of pools. The variant filtering apparatus 220 filters a standard variant detection result of pools, detected by the pooling test apparatus 200. The pooling test apparatus 200 transmits the pooling test results to the pooling test management apparatus 210 only when the standard variant detection result is not filtered.

Based on pre-accumulated variant frequency data, the variant filtering apparatus 220 determines whether the positive frequency is excessively high or not.

The variant filtering apparatus 220 may include variant frequency database. Variant data including data of variant positions, variant polymorphism, the total number of samples on which pooling tests are performed, and the number of predicted positive samples, may be stored in the variant frequency database. Probabilities of occurrence of the standard variant may vary according to the position of the standard variant. Therefore, the positive frequency may differ according to the standard variant pattern.

The variant frequency database may include frequencies in public database, such as 1000 genomes (Durbin et al. Nature 2010), data concerning variant-associated diseases, and so on. If an identical variant pre-exists in the database, the total number of existing samples and the number of positive samples are updated. The variant frequency database may include various sets of database according to purposes of use or characteristics of test subjects to then be selectively used to be adaptive to characteristics of pooling test subjects.

The variant filtering apparatus 220 provides the positive frequency data for standard variant detection to the pooling test apparatus 200. When the positive frequency is excessively high, the pooling test apparatus 200 may perform the pooling test again or reexamine samples predicted as erroneous samples.

FIG. 4 is a diagram illustrating an exemplary operation of discriminating positive samples using pooling test results.

Allele frequencies of the respective pools, representing intensities of positive reactions to the standard variant, are measured. Here, if pools P1, P5 and P8 demonstrate positive reactions, positive samples can be discriminated using pools intersecting on the matrix. Samples S1 and S13 positioned at intersections where black lines arranged on the matrix shown in FIG. 4 are discriminated as the positive samples.

Here, the allele frequency of the pool P1 may be equal to an approximately sum of the allele frequencies of the pools P5 and P8.

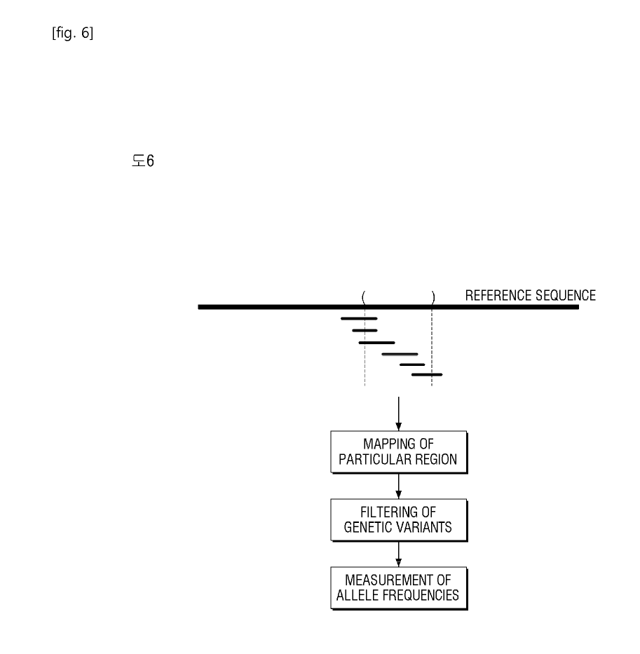

FIG. 5 is a diagram illustrating an exemplary case where false positive samples are included in pooling test results.

When pools X2, X3 and X4 shown in FIG. 5 are detected as positive pools and pools Y2, Y3 and Y4 are detected as positive pools, a total number of samples positioned at the cross pools cross pools shown in FIG. 4 is 9. However, if only S6, S7, S11 and S16 are actual positive samples, as shown in FIG. 5, the samples S10, S14, S15, S8 and S12 are not actual positive samples but are discriminated as positive samples.

In FIG. 5, since four of 16 samples in total are actual positive samples, the positive frequency should be 0.25. However, according to the pooling test results, nine of 16 samples in total are positive samples, the positive frequency is approximately 0.56. Therefore, the pooling test results of FIG. 4 may be filtered using the accumulated positive frequency data.

As shown in FIG. 5, it is necessary to individually perform standard variant detection for the samples S6, S7, S8, S10, S11, S12, S14, S15 and S16.

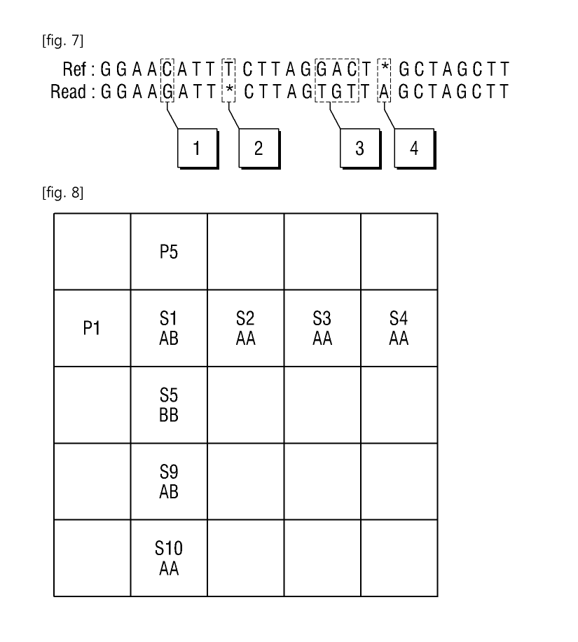

FIG. 6 is a diagram illustrating a method for measuring allele frequency for a standard variant according to an embodiment of the present invention. Since the standard variant has a different base sequence from the reference sequence, reads pooled in each pool are mapped to the reference sequence for standard variant detection.

A particular region of the reference sequence is designated and the reads pooled in each pool are mapped to the particular region of the reference sequence. The mapping of the reads to the reference sequence is illustrated in FIG. 6. The standard variant to be detected in the pooling test may be extracted from data concerning the reads mapped to the particular region of the reference sequence. The allele frequency may be measured from the detected standard variant.

FIG. 7 is a diagram illustrating standard variant patterns.

In a reference sequence (Ref), the human gene map consists of bases A, G, C and T. Here, the read is mapped to the reference sequence (Ref).

A first pattern of the standard variant (labeled 1 in FIG. 7) is a substitution. The read has a base G in a place C of the reference sequence (Ref). The substitution refers to a case in which a base sequence of the read is different from that of the reference sequence (Ref).

A second pattern of standard variant (labeled 2 in FIG. 7) is a deletion. A base T exists in the reference sequence (Ref) but a base with respect to the base T of the reference sequence (Ref) is missing. The deletion refers to a case in which one base is missing in the reference sequence (Ref) and base sequences following the missing base are mapped.

A third pattern of standard variant (labeled 4 in FIG. 7) is an insertion.

The insertion refers to a case in which one missing base of the reference sequence (Ref) is added with a base A in the read and base sequences following the added base are mapped.

In addition to the single base variation of standard variant, multiple base variation of standard variant may also occur, like in a base labeled 3 of FIG. 7. The multiple base variation refers to a variation in which one of the three patterns of standard variant consecutively appears.

Since there are numerous patterns of the standard variant and variations appear in different probabilities according to the location of the reference sequence (Ref), positive frequencies may vary according to standard variant patterns.

FIG. 8 is a diagram illustrating allele frequencies in a case where the standard variant is B in two pools determined as positive pools.

As shown in FIG. 8, let a genetic trait having the standard variant be B, pools P1 and P5 each having four samples demonstrate positive reactions to the genetic trait B. However, only the sample S1 is a positive sample in the pool P1 and the samples S1, S5 and S9 are positive samples in the pool P5.

In order to determine whether a pool is a positive pool, the allele frequency of the pool is measured. In individually measuring allele frequencies of the respective samples, if the samples have allele frequencies of 0.5 or greater, they may be determined to be positive samples. Therefore, in a case where the allele frequency of a heterozygous genotype is greater than or equal to a minimum allele frequency reference value calculated by the formula (1), the pool may be determined to be positive pool:

Minimum allele frequency reference value=(Minimum allele frequency of positive sample)/Number of pooled samples (1).

Since the pool having the allele frequency greater than the minimum allele frequency reference value calculated by the formula (1) is determined as a positive pool, the positive pool may have different allele frequencies.

Referring to FIG. 8, the pool P1 has one genetic trait B while the pool P5 has four genetic traits B. Therefore, the allele frequency of the pool 5 is approximately 4 times greater than that of the pool P1.

In the present invention, in order to accumulate positive frequency data for determining false positives, a ratio of the number of positive samples to the total number of pools is required. Therefore, in accumulating the positive frequency data, the number of positive samples may be predicted based on the allele frequency value measured for the pool without a need for determining which one of the samples is a positive sample.

The larger the allele frequency value measured for the pool, the greater the number of positive samples contained in the pool. Based on this finding, the best guess calculating method will now be described. However, a calculating process is required in predicting the number of positive samples contained in the pool based on the allele frequency value. Therefore, according to the present invention, the minimum number calculating method for predicting the minimum number of positive samples without the calculating process is also proposed.

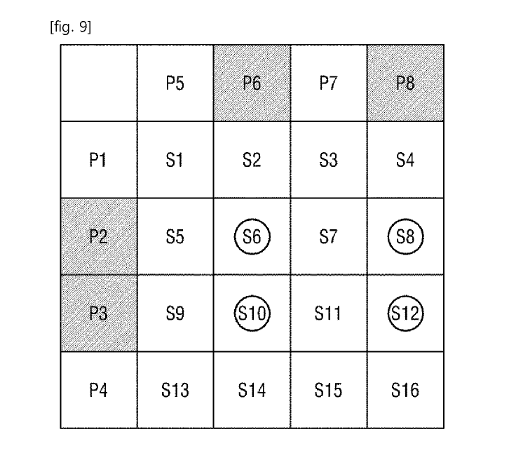

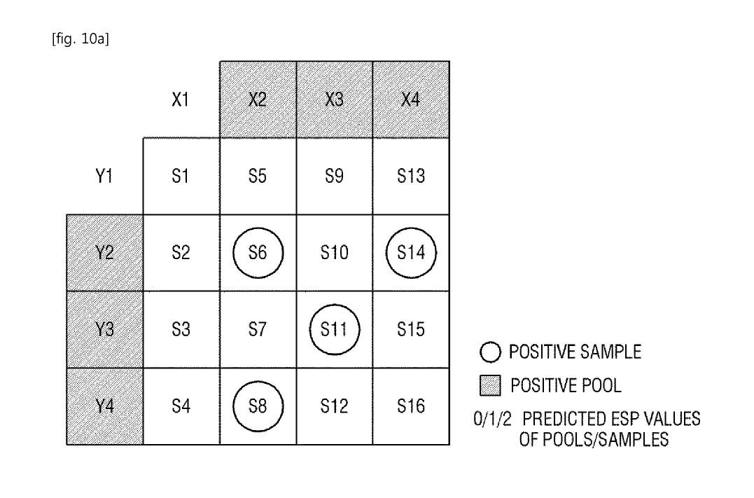

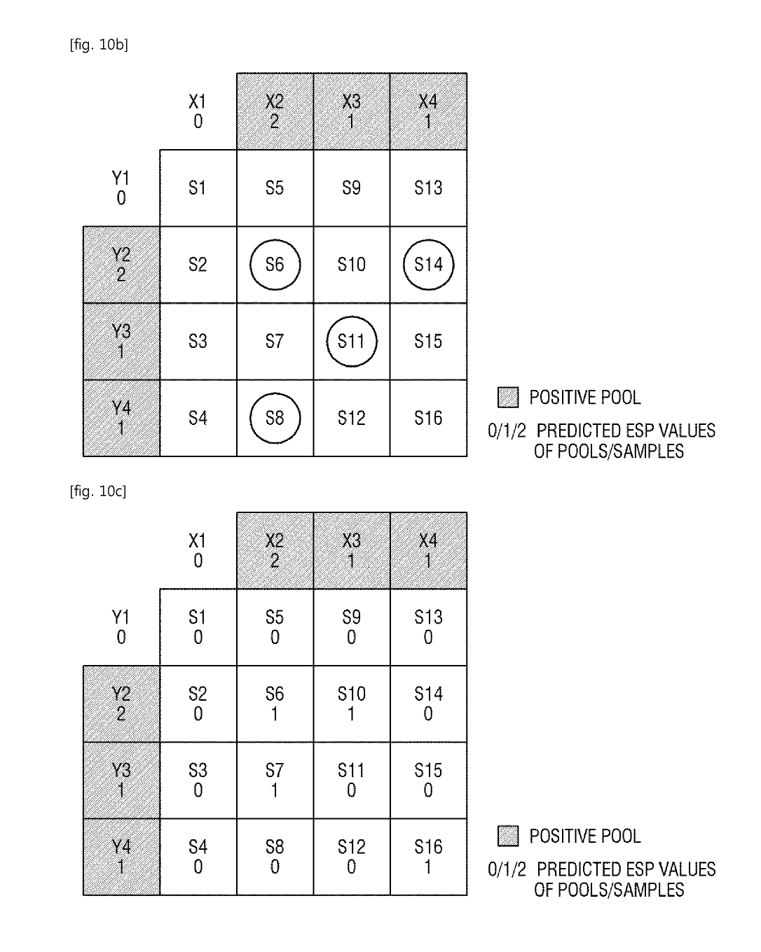

FIG. 9 and FIGS. 10A to 10C are diagrams illustrating a method for predicting the number of positive samples according to an embodiment of the present invention using a minimum number calculating method and a best guess calculating method.

The minimum number calculating method and the best guess calculating method will now be described with reference to FIGS. 9 and 10.

First, according to the minimum number calculating method, when the pools are detected as positive pools, the number of positive samples is predicted only based on whether the pools are positive. In FIG. 9, pools P2, P3, P6 and P8 are positive pools. When the positive pools are made to cross each other on a 2D matrix, four samples S6, S8, S10 and S12 are positioned at intersections of the positive pools.

The minimum number calculating method is used to predict the minimum number of positive samples, which can be obtained from the resulting positive pools. In FIG. 9, four samples S6, S8, S10 and S12 may be potential positive samples. Specifically, there may be various combinations of potential positive samples, including all of the four samples S6, S8, S10 and S12, only the samples S6, S10 and S12, only the samples S10, S8 and S12, and so on.

However, the minimum number of positive samples required for the four pools of FIG. 8 to be positive pools is 2. For example, if the samples S6 and S12 are positive samples or the samples S8 and S10 are positive samples, four pools P6, P8, P2 and P3 may be positive pools.

According to the embodiment of the present invention, positive frequency data may be accumulated based on only the number of positive samples without a need for discriminating positive samples, so that the minimum number of positive samples, i.e., two (2), may be predicted as the number of positive samples.

The minimum number calculating method may be given in the following formula (2):

Minimum number of positive samples=MAX(X,Y) (2)

where X represents the number of pools of rows demonstrating positive reactions and Y represents the number of pools of columns demonstrating positive reactions, on the 2D (n*m) matrix. When the example of FIG. 9 is substituted to the formula (2), MAX (2,2)=2, which is equal to the minimum number of positive samples.

FIGS. 10A to 10C are diagrams illustrating a method for predicting the number of positive samples according to an embodiment of the present invention using a best guess calculating method.

Referring to FIG. 10A, let samples S6, S8, S11 and S14 be actual positive samples. When standard variant detection is performed on pools, pools X2, X3, X4, Y2, Y3 and Y4 are detected as positive pools. Since the pool Y2 contains more positive samples than the pool Y3 or Y4, the measured allele frequency of the pool Y2 should be greater than that of the pool Y3 or Y4.

According to the best guess calculating method, it is possible to predict the number of predicted DNA strands with alternative allele observed from the positive pools, which will be briefly referred to as a predicted positive strand (EPS) value, based on the measured allele frequency.

As described above in FIG. 8, when two positive samples having heterozygous genotype AB and homozygous genotype BB and two negative samples having genotype AA are pooled for standard variant detection, the EPS value, that is, the number of DNA strands with alternative allele B, is 3. Referring to FIG. 8, the pool P1 has an EPS value of 1 and the pool P5 has an EPS value of 4.

Since human DNA strands are of diploid type, the maximum EPS value is 8 when four samples are pooled, and the maximum EPS value of each sample is 2. In the illustrated example of FIG. 8, the sample having the maximum EPS value is the sample S5.

When only positive samples are contained in the pools, as illustrated in FIGS. 10A to 10C, let all of the positive samples have heterozygous genotype variants. Therefore, the maximum EPS value of each sample may be 2.

According to the best guess calculating method, as illustrated in FIG. 10B, EPS values can be predicted from allele frequencies of the pools. The following EPS values may be obtained as the prediction results.

TABLE 1

| Pool | EPS value |
|---|---|
| X1 | 0 |
| X2 | 2 |
| X3 | 1 |
| X4 | 1 |
| Y1 | 0 |
| Y2 | 2 |
| Y3 | 1 |
| Y4 | 1 |

As listed in Table 1, when the EPS values of the respective pools are predicted from the allele frequencies of the respective pools, EPS values of samples contained in the respective pools may be predicted by the following algorithm.

First, identification numbers of the samples positioned on the 2D matrix may be represented by locations of rows and columns. For example, in FIG. 9B, since a sample S6 is positioned on row 2 and column 3, it may be discriminated as a sample positioned at (2,3). Here, the EPS values of the respective samples are predicted in orders of (1,2) . . . , (1,4), (2,1), . . . and (4,4) from the sample positioned at (1,1) on the 2D matrix.

The EPS value of a sample positioned at (i, j) is smallest among the EPS value of a pool i, the EPS value of a pool j, and EPS values of samples.

When the EPS value of sample (i, j) is 1 or greater, the EPS value of pool I and the EPS value of pool j are decremented by 1, respectively.

In such a manner, prediction results of ESP values of the respective samples shown in FIG. 10C are given below:
1. EPS value of sample S1=min (EPS value of pool X1, EPS value of pool Y1, maximum EPS value of sample)=min (0, 0, 1)=0;
2. EPS value of sample S5=min (EPS value of pool X2, EPS value of pool Y1, maximum EPS value of sample)=min (2, 0, 1)=0;
3. EPS value of sample S9=min (EPS value of pool X3, EPS value of pool Y1, maximum EPS value of sample)=min (1, 0, 1)=0;
4. EPS value of sample S13=min (EPS value of pool X4, EPS value of pool Y1, maximum EPS value of sample)=min (1, 0, 1)=0;
5. EPS value of sample S2=min (EPS value of pool X1, EPS value of pool Y2, maximum EPS value of sample)=min (0, 2, 1)=0;
6. EPS value of sample S6=min (EPS value of pool X2, EPS value of pool Y2, maximum EPS value of sample)=min (2, 2, 1)=1;
7. EPS value of pool X2=EPS value of existing pool X2−EPS value of sample S6=2−1=1;
8. EPS value of pool Y2=EPS value of existing pool Y2−EPS value of sample S6=2−1=1;
9. EPS value of sample S10=min (EPS value of pool X3, EPS value of pool Y2, maximum EPS value of sample)=min (1, 1, 1)=1;
10. EPS value of pool X3=EPS value of existing pool X3−EPS value of sample S10=1−1=0;
11. EPS value of pool Y2=EPS value of existing pool Y2−EPS value of sample S10=1−1=0;
12. EPS value of sample S14=min (EPS value of pool X4, EPS value of pool Y2, maximum EPS value of sample)=min (1, 0, 1)=0;
13. EPS value of sample S3=min (EPS value of pool X1, EPS value of pool Y3, maximum EPS value of sample)=min (0, 1, 1)=0;
14. EPS value of sample S7=min (EPS value of pool X2, EPS value of pool Y3, maximum EPS value of sample)=min (1, 1, 1)=1;
15. EPS value of pool X2=EPS value of existing pool X2−EPS value of sample S7=1−1=0;
16. EPS value of pool Y3=EPS value of existing pool Y3−EPS value of sample 7=1−1=0;
17. EPS value of sample S11=min (EPS value of pool X3, EPS value of pool Y3, maximum EPS value of sample)=min (0, 0, 1)=0;
18. EPS value of sample S15=min (EPS value of pool X4, EPS value of pool Y3, maximum EPS value of sample)=min (1, 0, 1)=0;
19. EPS value of sample S4=min (EPS value of pool X1, EPS value of pool Y4, maximum EPS value of sample)=min (0, 1, 1)=0;
20. EPS value of sample S8=min (EPS value of pool X2, EPS value of pool Y4, maximum EPS value of sample)=min (0, 1, 1)=0;
21. EPS value of sample S12=min (EPS value of pool X3, EPS value of pool Y4, maximum EPS value of sample)=min (0, 1, 1)=0;
22. EPS value of sample S16=min (EPS value of pool X4, EPS value of pool Y4, maximum EPS value of sample)=min (1, 1, 1)=1;
23. EPS value of pool X4=EPS value of existing pool X4−EPS value of sample 16=1−1=0;
24. EPS value of pool Y4=EPS value of existing pool Y4−EPS value of sample 16=1−1=0; and
25. Number of predicted positive samples=Number of samples having EPS values of 0 or greater=4.

Referring to FIG. 10C, the samples S6, S7, S10 and S16 predicted as positive samples by the best guess calculating method are slightly different from actual positive samples, e.g., samples S6, S8, S11 and S14. In the present invention, however, the best guess calculating method may be suitably employed for the purpose of predicting the number of positive samples, not for the purpose of discriminating positive samples.

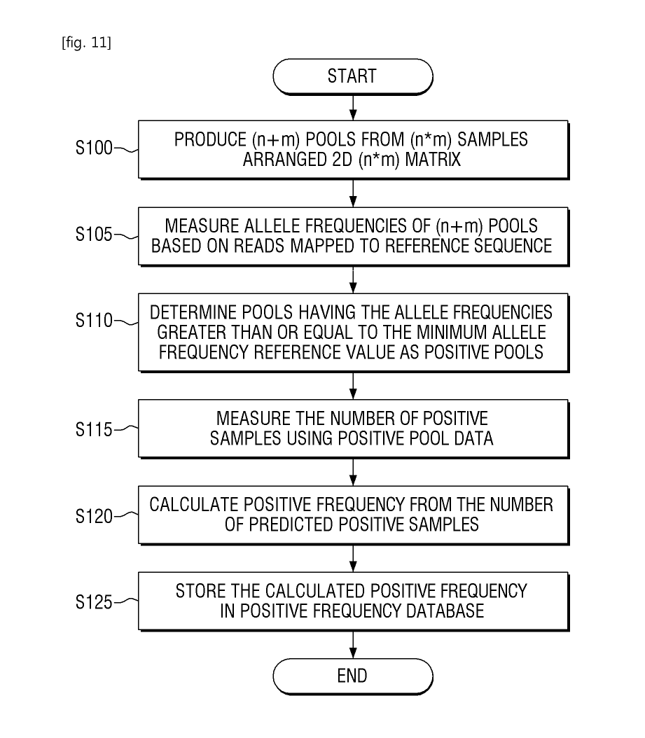

FIG. 11 is a flowchart of a method for accumulating positive frequencies for determining false positives according to an embodiment of the present invention.

Samples arranged on the 2D (n*m) matrix are pooled to produce (n+m) pools (S100). Allele frequencies of the respective (n+m) pools are measured (S105). The allele frequencies of the respective pools are measured based on the number of reads mapped to a reference sequence. If there are pools having the allele frequencies greater than or equal to the minimum allele frequency reference value, obtained by the formula (1), among the allele frequencies of the respective (n+m) pools, the pools are determined as positive pools (S110). The number of positive samples is predicted using data concerning the positive pools (S115). In the present invention, the minimum number calculating method and the best guess calculating method are introduced as exemplary methods for predicting the number of positive samples, but aspects of the present invention are not limited thereto.

A positive frequency may be calculated from the number of predicted positive samples (S120). In FIG. 10C, four of 16 samples in total are positive samples, the positive frequency is 0.25.

The calculated positive frequency is stored in positive frequency database (S125). The thus stored positive frequency data may later be used for filtering positive samples or for filtering variants detected from pooling tests. Meanwhile, the positive frequency data stored in the positive frequency database is preferably used for filtering positive samples only when the total number of samples subjected to pooling tests is larger than or equal to a predetermined number of samples.

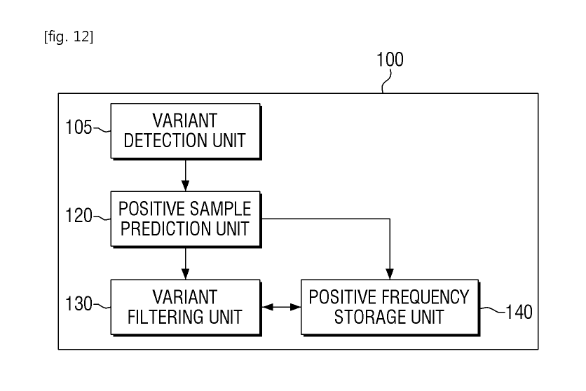

FIG. 12 is a block diagram of a pooling test apparatus (100) according to an embodiment of the present invention.

The pooling test apparatus 100 may include a variant detection unit 105, a positive sample prediction unit 120, a variant filtering unit 130, and a positive frequency storage unit 140.

The variant detection unit 105 detects a standard variant by mapping reads contained in the pools to the reference sequence using genome sequencing. The variant detection unit 105 may measure allele frequencies using the reads having the standard variant. The variant detection unit 105 determines based on the measured allele frequencies whether the respective pools are positive or not, and supplies the allele frequency values to the positive sample prediction unit 120.

The positive sample prediction unit 120 may predict positive samples using the positive pool data. The positive sample prediction unit 120 may not discriminate positive samples but may predict only the number of positive samples. Here, the minimum number calculating method or the best guess calculating method may be employed. The positive sample prediction unit 120 may calculate the positive frequency using the total number of samples subjected to pooling tests and the number of positive samples.

The positive sample prediction unit 120 may supply the positive frequency data to the positive frequency storage unit 140. Here, the variant filtering unit 130 may filter false positives from the positive frequency data. In order to ensure reliability of the positive frequency data to be stored, the positive frequency data may be stored in the positive frequency storage unit 140 only when the total number of samples subjected to pooling tests is larger than or equal to a predetermined number.

The variant filtering unit 130 determines whether the number of positive samples predicted by the positive sample prediction unit 120 is appropriate or not using positive frequency values stored to correspond to the standard variant, and if not, the number of positive samples predicted by the positive sample prediction unit 120 may not be stored in the positive frequency storage unit 140.

The positive frequency storage unit 140 may store positive frequency data according to the standard variant pattern. As illustrated in FIG. 7, there are many patterns of the standard variant, different variants are produced according to DNA data and DNA position data in the reference sequence. Therefore, when the standard variant data is to be stored, DNA data, DNA position data and sample type data are all preferably stored and the positive frequency data is preferably stored so as to correspond to the stored DNA data, DNA position data and sample type data.

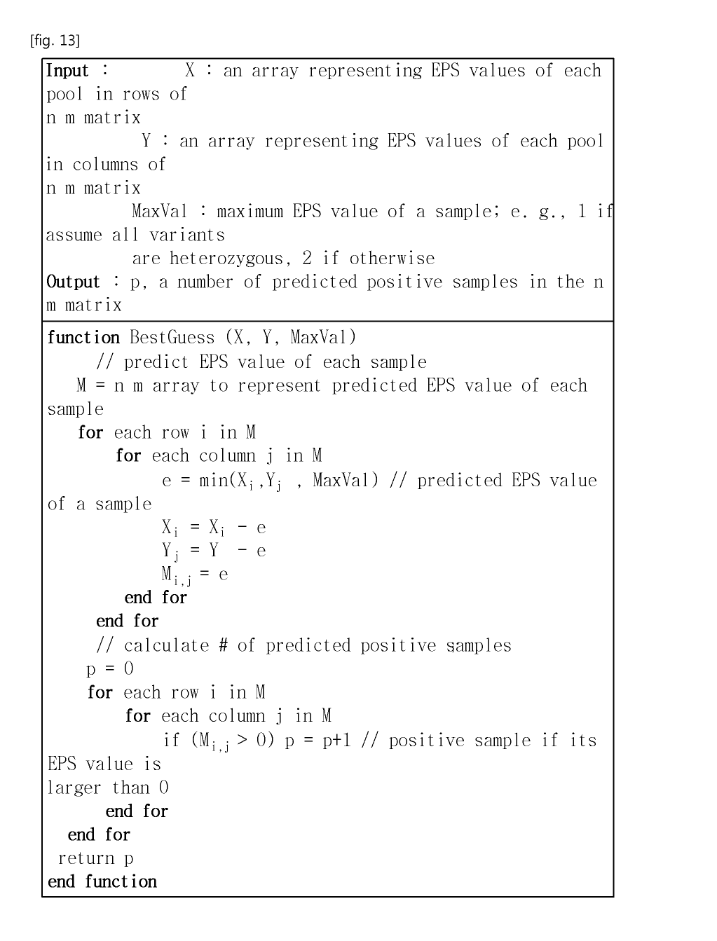

FIG. 13 is a diagram illustrating an algorithm of a best guess calculating method according to an embodiment of the present invention.

The algorithm illustrated in FIG. 13 will now be described by way of example with reference to FIG. 10C, where X represents pools of rows on the 2D matrix and Y represents pools of columns on the 2D matrix. Since positive samples are all heterozygous, as assumed above in FIG. 10C, the MaxVal value is 1.

When the samples included in the pools are represented by (i, j), ESP values of samples are obtained by the following formula (3):

EPS of M_{(i,j)}=min(Xᵢ,Yⱼ,MaxVal) (3)

where if the M_{(i,j)} value is larger than 1, the ESP value of M_{(i,j)} should be subtracted from the ESP value of the pool of M_{(i,j)} so as to make the EPS of M_{(i,j)} equal to the EPS value of pool (Xᵢ, Yⱼ). Therefore, after the EPS of M_{(i,j)} is calculated, the EPS value of pool (Xᵢ, Yⱼ) should be updated.

After ESP values of M_{(i,j)} in the 2D matrix are all calculated, the number of M_{(i,j)} having EPS values larger than 1 is calculated. Since the number of M_{(i,j)} is predicted as the number of positive samples, it is returned and the number of positive samples is returned and the algorithm shown in FIG. 113 is ended.

FIG. 14 is a graph illustrating comparison of the numbers of predicted positive samples obtained by a minimum number calculating method and a best guess calculating method with the number of actual positive samples.

For comparison, 1000 test cases in which positive samples are randomly generated among a total number of test samples, i.e., 64, are produced by 8×8 matrix pooling tests, the number of positive samples is predicted for each test case, and a ratio of the number of predicted positive samples to the number of actual positive samples is obtained. If the ratio of the number of predicted positive samples to the number of actual positive samples is 1, the number of predicted positive samples is equal to the number of actual positive samples.

When the ratio is referred to as being 1 or larger, it may mean that the positive samples are over-predicted and when the ratio is referred to as being smaller than 1, it may mean that the positive samples are under-predicted. Points shown on FIG. 14 correspond to mean values of ratios of the number of predicted positive samples to the number of actual positive samples in 1000 test cases.

In FIG. 14, the positive samples having variants of only heterozygous genotype are represented by ‘Het Only’ and the positive samples having 80% variants of heterozygous genotype and 20% variants of homozygous genotype are represented by (Hom0.8, Het0.2).

The minimum number calculating method is advantageous in that it can be simply performed because the ESP values are not necessarily predicted from allele frequencies. However, if the number of positive samples in each pool is increased, as shown in FIG. 14, the extent of under-prediction may become excessively high.

Meanwhile, compared to the minimum number calculating method, the best guess calculating method enables prediction of the number of positive samples to be approximate to the number of actual positive samples on the assumption that samples exist in the respective pools in substantially the same ratio. In particular, when only heterozygous genotype variants exist, the number of predicted positive samples is always approximate to the number of actual positive samples.

In a case where quite many positive samples are subjected to pooling tests, as shown in FIG. 14, it is not possible to accurately predict the number of actual positive samples. However, since the standard variant used for pooling tests is preferably suitable when the positive frequency is low, the frequency of occurrences of variants may be considerably helpful in filtering frequently observed variants.

The respective components shown in FIG. 14 may mean, but not limited to, a software or hardware component, such as a field programmable gate array (FPGA) or an application specific integrated circuit (ASIC). The respective components may be configured to reside in an addressable storage medium and configured to execute on one or more processors. The functionality provided for the components may be combined into fewer components or further separated into additional components.

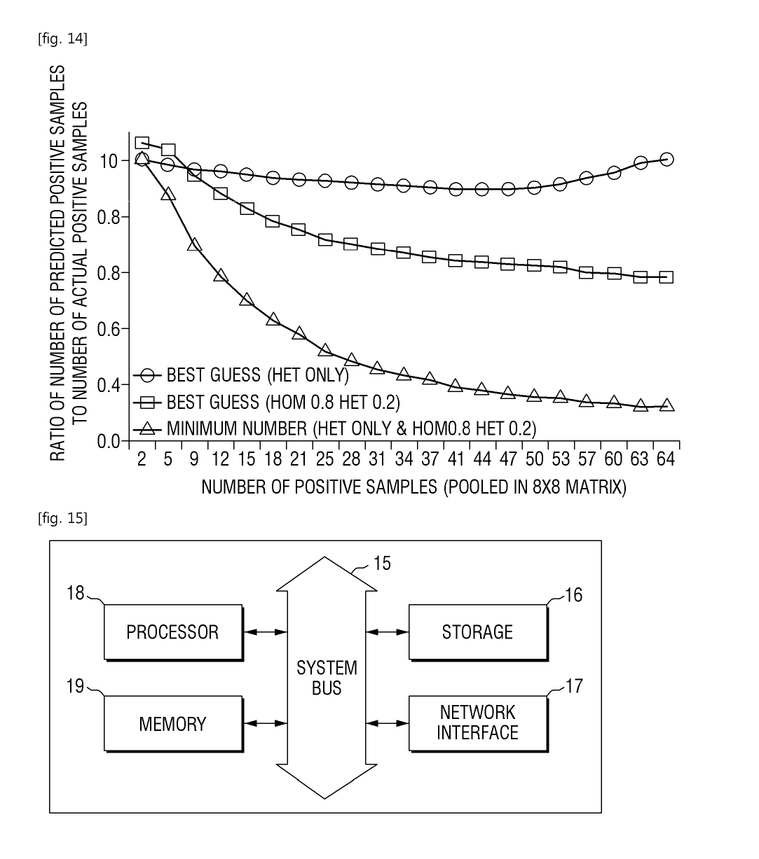

FIG. 15 is a hardware diagram of a pooling test apparatus (100) according to an embodiment of the present invention.

The pooling test apparatus 100 may have the same configuration as illustrated in FIG. 12.

The pooling test apparatus 100 may include a processor 150 for executing various instructions, a storage 156 in which pooling test result data is stored, a memory 152, a network interface 158 for transmitting/receiving data to/from an external device, and a system bus 154 connected to the storage 156, the network interface 158, the processor 150 and the memory 152 and functioning as a data movement passageway.

A computer program providing a function of filtering pooling test results using positive frequency data may include a series of data receiving instructions of receiving data concerning positive pools as the results of pooling tests performed on a standard variant on a 2D matrix, a series of predicting instructions of measuring allele frequencies of the positive pools to predict the number of positive samples for the standard variant using the positive pool data, predicting the number of DNA strands having alleles based on the measured values of the allele frequencies, and predicting the number of positive samples based on the number of predicted DNA strands, and a series of calculating instructions of calculating positive frequencies based on the number of positive samples.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A method for accumulating positive frequency data for determining false positives, the method comprising:
receiving pooling test result data of pooling tests performed on a plurality of pools arranged in a two dimensional (2D) matrix, the matrix comprising a plurality of rows and a plurality of columns, the pooling test result data including allele frequencies of positive pools reacting positively with a standard variant;
predicting a number of positive samples reacting positively with the standard variant from the allele frequencies of the positive pools;
calculating a positive frequency for the standard variant from the predicted number of positive samples; and
updating the positive frequency for the standard variant in a positive frequency database.

2. The method of claim 1, wherein the predicting of the number of positive samples comprises predicting a minimum number of positive samples, which is obtained by the following formula:
(Minimum number of positive samples)=MAX(X,Y)
where X represents a number of pools associated with rows of the matrix reacting positively, and Y represents a number of pools associated with columns of the matrix reacting positively.

3. The method of claim 1, wherein the predicting of the number of positive samples comprises:
measuring allele frequencies of the positive pools;
predicting a number of predicted deoxyribonucleic acid (DNA) strands with alternative allele (EPS) for the positive pools based on the allele frequencies of the positive pools;
predicting EPS values of respective samples contained in the positive pools based on the EPS values of respective positive pools; and
calculating a number of positive samples each having an EPS value of 1 or greater contained in the positive pools.

4. The method of claim 3, wherein the predicting of the number of positive samples further comprises calculating EPS values of all samples contained in the plurality of pools, obtained by the following formula:
(EPS values of samples)=min(EPS of pools of rows for samples, EPS of pools of columns for samples, maximum EPS value of samples)
where the maximum EPS value of samples is 1 when the standard variant has a heterozygous genotype and is 2 when the standard variant has a homozygous genotype.

5. A method for filtering false positive samples from pooling test results, the method comprising:
detecting a standard variant for a plurality of pools, the plurality of pools comprising a plurality of samples;
predicting a number of positive samples reacting positively with the standard variant based on positive pool data indicating a number of positive pools reacting positively with the standard variant;
measuring positive frequencies using the predicted number of positive samples; and
comparing the measured positive frequencies with pre-accumulated positive frequency values and filtering the measured positive frequencies when a number of measured positive frequencies is beyond a predefined number of errors.

6. A computer program recorded in a non-transient computer-readable recording medium in association with a computing device, the computer program executing a method for filtering pooling test results using positive frequency data, the method comprising:
receiving pooling test result data performed on a plurality of pools arranged in a two dimensional (2D) matrix, the matrix comprising a plurality of rows and a plurality of columns, the pooling test result data including positive pool data concerning positive pools reacting positively with a standard variant;
measuring allele frequencies of the positive pools to predict a number of positive samples reacting positively the standard variant from the positive pool data;
predicting a number of deoxyribonucleic acid (DNA) strands having alleles corresponding to the standard variant in the positive pools from data concerning the allele frequencies of the positive pools;
predicting a number of DNA strands having alleles corresponding to the standard variant in the samples contained in the positive pools from the predicted number of DNA strands having alleles corresponding to the standard variant in the positive pools;
predicting a number of positive samples from the predicted number of DNA strands having alleles corresponding to the standard variant in the samples; and
predicting positive frequencies from the predicted number of positive samples.

7. A pooling test apparatus for filtering false positive samples, the pooling test apparatus comprising:
one or more processors;
a network interface;
a non-transient computer-readable memory; and
a storage device loaded on the memory and having a computer program recorded therein, the computer program executed by the one or more processors,
wherein the computer program comprises:
a series of data receiving instructions for receiving data concerning positive pools as a result of pooling tests performed on a standard variant on a two dimensional matrix;
a series of predicting instructions for measuring allele frequencies of the positive pools to predict a number of positive samples reacting positively with the standard variant using the data concerning the positive pools, predicting a number of deoxyribonucleic acid (DNA) strands having alleles based on the measured allele frequencies, and predicting the number of positive samples based on the predicted number of DNA strands; and
a series of calculating instructions for calculating positive frequencies based on the predicted number of positive samples.
